(19) United States
(12) Patent Application Publication
(10) Pub. No.: US 2009/0228562 A1
(43) Pub. Date: Sep. 10, 2009

(54) MAIL SENDING AND RECEIVING APPARATUS, METHOD, COMPUTER-READABLE MEDIUM AND SYSTEM

(75) Inventors: Atsushi UCHIYAMA, Nagano (JP); Jun YAMAZAKI, Nagano (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/359,273

(22) Filed: Jan. 23, 2009

(30) Foreign Application Priority Data
Jan. 23, 2008 (JP) 2008-012087

(51) Int. Cl. G06F 15/16

(52) U.S. Cl. 709/206

(57) ABSTRACT

A method, to facilitate sending and receiving e-mails, includes: reading mail information from a mail-information memory regarding accessible e-mail accounts to which an authenticated user is permitted to have access; providing the mail information specific to a first one of the accessible email accounts; receiving a switching instruction to switch to a second one of the accessible email accounts; and automatically providing the mail information specific to the second one of the accessible email accounts upon accepting the switching instruction. The method may further include: accepting a reply instruction for creating a reply mail relative to an e-mail read at the second one of the accessible email accounts; and setting a reply address for the reply email to be the address associated with the second one of the accessible email accounts.

### CROSS-REFERENCE TO RELATED APPLICATIONS

This application is based upon and claims the benefit of priority of the prior Japanese Patent Application No. 2008-012087, filed on Jan. 23, 2008, the entire contents of which are incorporated herein by reference.

### FIELD

The present embodiment discussed herein is directed to mail sending and receiving programs, mail sending and receiving apparatuses, and mail sending and receiving systems for sending and receiving e-mails.

### BACKGROUND

The present techniques relate to mail sending and receiving programs, mail sending and receiving apparatuses, and mail sending and receiving systems for sending and receiving e-mails. Particularly, the present techniques relate to a mail sending and receiving program, a mail sending and receiving apparatus, and a mail sending and receiving system with which it is possible to manage a mail account shared by a plurality of users.

With popularization of e-mails, state institutions, local governments, private companies, and other organizations have been using more and more e-mails for sending and receiving information to and from within and outside the organizations.

These organizations use mail addresses of the organization for contacting to the organization as a whole or mail addresses of subgroups of the organization (e.g., a department, a division, and a project team) for contacting to the subgroups (hereunder called representative addresses) in addition to personal mail address of persons in charge.

Regarding to this, a technique to transfer an e-mail directed to a representative address to registered multiple addresses as a broad cast mail are known (e.g., refer to Japanese Laid-open Patent Publication No. 2002-82876). This allows confirming and sharing the content of the e-mail received at the representative address throughout the subgroup.

There is a webmail software (hereunder, called “web mail” to read electronic mails on a browser software instead of on a mailer software. Using a webmail can ensure security, because all messages are managed by a server-side.

### SUMMARY

An embodiment of the invention provides a method to facilitate sending and receiving e-mails, the method including: reading mail information from a mail-information memory regarding accessible e-mail accounts to which an authenticated user is permitted to have access; providing the mail information specific to a first one of the accessible email accounts; receiving a switching instruction to switch to a second one of the accessible email accounts; and automatically providing the mail information specific to the second one of the accessible email accounts upon accepting the switching instruction. The method may further include: accepting a reply instruction for creating a reply mail relative to an e-mail read at the second one of the accessible email accounts; and setting a reply address for the reply email to be the address associated with the second one of the accessible email accounts.

### BRIEF DESCRIPTION OF THE DRAWINGS

FIG. 1 is a diagram showing an overview of an embodiment;

FIG. 2 is a diagram showing the system configuration according to the embodiment;

FIG. 3 is a diagram showing the hardware configuration of a mail server;

FIG. 4 is a block diagram showing functions of the mail server;

FIG. 5 is a diagram showing the data structure of an association table;

FIG. 6 is a diagram showing the data structure of a group table;

FIG. 7 is a diagram showing the data structure of an address table;

FIG. 8 is a diagram showing the data structure of a mail opening table;

FIG. 9 is a flowchart showing the procedure of a mailbox process;

FIG. 10 is a sequence diagram showing the procedure of a process for reading an e-mail in a mail system;

FIG. 11 is an illustration showing a log-in screen;

FIG. 12 is an illustration showing a post-log-in screen;

FIG. 13 is an illustration showing an account display screen for a personal address;

FIG. 14 is an illustration showing an account display screen for a representative address; and

FIG. 15 is an illustration showing a reply-mail creating screen.

### DESCRIPTION OF EMBODIMENT

Now, an embodiment will be described with reference to the drawings.

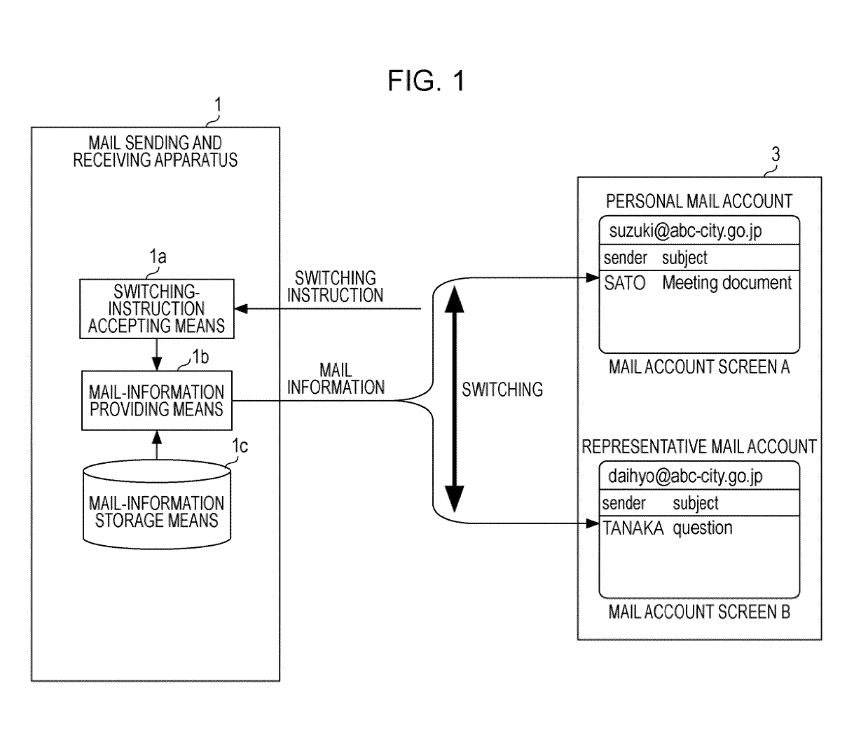

FIG. 1 is a diagram showing an overview of the embodiment. A mail sending and receiving apparatus shown in FIG. 1 sends and receives e-mails. Furthermore, the mail sending and receiving apparatus manages a plurality of mail accounts. A mail sending and receiving apparatus 1 is implemented by a computer functioning as described below according to a mail sending and receiving program. The mail sending and receiving apparatus 1 sends and receives e-mails and manages a plurality of mail accounts. The mail sending and receiving apparatus 1 includes switching-instruction accepting unit 1a, mail-information providing unit 1b, mail-information storage unit 1c.

The switching-instruction accepting unit 1a accepts a switching instruction for switching an account for which mail information is provided by the mail-information providing unit 1b from one account to another. The switching instruction is issued by a user who reads e-mails in order to switch e-mails displayed on a display screen 3.

The mail-information providing unit 1b reads mail information from the mail-information storage unit 1c, and provides the mail information that has been read for each of account for management of e-mails. On the basis of the mail information provided by the mail-information providing unit 1b, the content of e-mails and other information of an account that the user wishes to use for reading are displayed on a display screen on which the user can read e-mails.

The mail-information providing unit 1b switches the account for which mail information is read from the mail-information storage unit 1c and is provided from one account to another account according to the switching instruction accepted by the switching-instruction accepting unit 1a. Accordingly, the mail information provided by the mail-information providing unit 1b is switched from that of the one account to that of the other account according to the switching instruction. Thus, it is possible to switch the content displayed on the display screen 3 according to the switching instruction by the user, for example, between a mail account screen A showing e-mails sent to a personal mail account and a mail account screen B showing e-mails sent to a representative mail account.

The mail-information storage unit 1c stores mail information relating to e-mails. The mail information includes a body, a source address, a destination address, a date and time of sending, and so forth for each e-mail. The content and other information of e-mails are displayed on the display screen 3 on the basis of the mail information.

With the mail sending and receiving apparatus 1 described above, the mail-information storage unit 1c stores mail information. The mail-information providing unit 1b reads mail information and provides the mail information that has been read for each account. The switching-instruction accepting unit 1a accepts a switching instruction. According to the switching instruction, the mail-information providing unit 1b switches the account of mail information to another account.

Accordingly, it is possible to switch an e-mail account for which mail information is provided by the mail server 100 among a plurality of accounts according to a switching instruction by the user. This facilitates reading and other management operations involving e-mails at a plurality of mail accounts by the user.

Now, the embodiment will be described in detail with reference to the drawings.

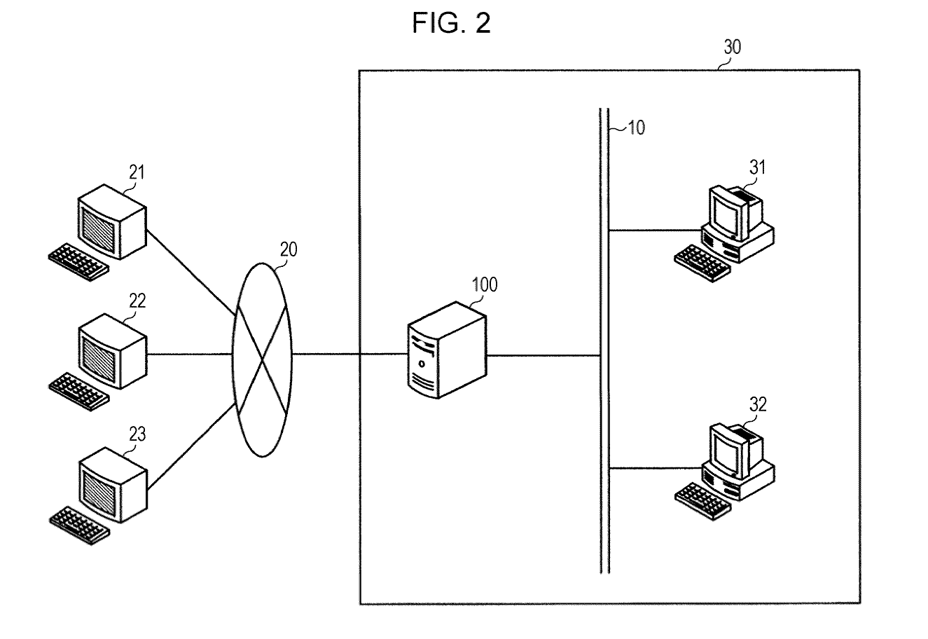

FIG. 2 is a diagram showing the system configuration of the embodiment. A mail system shown in FIG. 2 is a system for sending and receiving e-mails within an organization 30 and between the inside of the organization 30 and the outside (terminal apparatuses 21, 22, 23, . . . ) of the organization 30.

The scope of an organization is defined as appropriate. In the case of a company, for example, a department may be considered as an organization, or the entire company may be considered as an organization. Similarly, in the case of a local government, for example, a section may be considered as an organization, or the entire government may be considered as an organization.

In the mail system according to this embodiment, terminal apparatuses 31, 32, . . . are connected via a local area network (LAN) 10 to a mail server 100 for sending and receiving e-mails. Furthermore, the mail server 100 is connected to external terminal apparatuses 21, 22, 23, . . . via the Internet 20.

The mail server 100 sends and receives e-mails within the organization 30 and between the inside and outside of the organization 30. Furthermore, the mail server 100 manages e-mail accounts within the organization 30.

The mail server 100 has a function of storing internal mails created by users inside the organization 30 by using browsers on the terminal apparatuses 31, 32, . . . . Furthermore, the mail server 100 has a function of receiving e-mails sent from the outside to the inside of the organization 30 via the Internet 20 and storing the e-mails. These functions are implemented by a mail-opening-information storage unit 140, which will be described later.

Furthermore, the mail server 100 has a function of allowing users as recipients of e-mails, stored in the mail-opening-information storage unit 140, to perform operations on the e-mails as Web mails in accordance with requests from the users by using browsers on terminal apparatuses 31, 32, . . . . When a user wishes to read e-mails, the user is requested to enter a user ID and a password from a browser on one of the terminal apparatuses 31, 32, . . . , and the user is allowed to read internal mails written to the user from the inside of the organization 30 and external mails sent to the user from the outside of the organization 30 only when the user ID and password match authentication information registered in advance. On occasion of reading e-mails, the mail server 100 sends via the LAN 10 information representing the content of e-mails relevant to the user's reading request to the browser of one of the terminal apparatuses 31, 32, . . . (e.g., the terminal apparatus 31) that the user is operating. Upon receiving the information representing the content of the e-mail, the terminal apparatus 31 displays the content of the e-mails on the browser of the terminal apparatus 31.

Furthermore, the mail server 100 has a function of sending e-mails created by using the browsers of the terminal apparatuses 31, 32, . . . to the outside via the Internet 20. On occasion of sending of an e-mail, the mail server 100 accepts a user's request for creating and sending an e-mail according to the Hypertext Transfer Protocol (HTTP), and sends the e-mail to a destination (e.g., a user of the terminal apparatus 21) specified by the user according to the Simple Mail Transfer Protocol (SMTP), the Post Office Protocol (POP)/Internet Message Access Protocol (IMAP).

In this embodiment, e-mails that are stored under management by the mail server 100 and that can be operated on browsers by users within the organization 30 only from the terminal apparatuses 31, 32, . . . within the organization 30 are referred to as “Web mails”. Within the organization 30, the users can read external mails sent from the outside of the organization 30 to the mail server 100 as well as internal mails as Web mails.

Furthermore, the users belonging to the organization 30 may be allowed to read e-mails on the mail system by connecting to the mail server 100 from external terminal apparatuses (not shown) outside the organization 30 via the Internet 20. Also in this case, similarly to the case of using the terminal apparatuses 31, 32, . . . inside the organization 30, the users belonging to the organization 30 undergo authentication for log in based on user IDs and passwords by using terminals located outside the organization 30 and connected to the Internet 20. Thus, the users belonging to the organization 30 can read e-mails received at a representative address even when the users are outside the organization 30.

E-mails that are created at the terminal apparatuses 31, 32, . . . inside the organization 30 and exchanged among the users inside the organization 30 are referred to as “internal mails”. On the other hand, e-mails exchanged between users inside the organization 30 and the outside of the organization 30 via the Internet 20 and the mail server 100 are referred to as “external mails”.

In this embodiment, “e-mails” include both internal mails and external mails, and also include Web mails.

That is, an internal mail is created on the browser at one of the terminal apparatuses 31, 32, . . . inside the organization 30. The internal mail that has been created is stored in the mail server 100 as a Web mail, and only a user who has logged in by using an account within the organization 30 set as a destination of the internal mail is allowed to read the Web mail.

When an external mail is sent from the inside to the outside of the organization 30, a user creates the external mail by using the browser at one of the terminal apparatuses 31, 32, . . . , and in response to a sending instruction by the user, the external mail is sent temporarily from the mail server 100 via the Internet 20 to a mail server (not shown) that manages e-mails of a user at the destination. Then, for example, the external mail is sent from the mail server that manages e-mails of the user at the destination to one of the external terminal apparatuses 21, 22, 23, . . . used by the user at the destination.

As an example, description will be given in the context of a case where a user of the terminal apparatus 31 sends an external mail to a user of the external terminal apparatus 21 by using a mail address corresponding to a mail account managed by the mail server 100. In this case, according to a user's operation performed by using the browser at the terminal apparatus 31, upon creation of an e-mail addressed to the user of the terminal apparatus 21, the terminal apparatus 31 sends a body of the e-mail and a mail address of the user of the terminal apparatus 21 at the destination to the mail server 100 via the LAN 10. Upon receiving the mail address of the user of the terminal apparatus 21 at the destination and the mail body from the terminal apparatus 31, the mail server 100 sends the e-mail created by the user of the terminal apparatus 31 and including the mail body to the destination mail address.

On the other hand, when an external mail sent from the outside of the organization 30 via the Internet 20 is received by the mail server 100, similarly to the case of an internal mail, the external mail is stored at the mail server 100 as a Web mail, and only a user who has logged in by using an account within the organization 30 set as a destination of the external mail is allowed to read the Web mail on the browser at one of the terminal apparatuses 31, 32, . . . inside the organization 30.

As described above, the mail server 100 sends information of documents created by users within the organization 30 by using the terminal apparatuses 31, 32, . . . as external mails to the outside of the organization 30, and provides Web mails so that the users within the organization 30 can read e-mails by using the browsers running on the terminal apparatuses 31, 32, . . . and so that other users within the organization 30 can perform operations involving the e-mails created. As described above, the mail server 100 according to this embodiment sends and receives e-mails to and from the inside and outside of the organization 30, and manages received e-mails. With the mail server 100 according to this embodiment, it is possible to send an e-mail to addresses including destinations both inside and outside the organization 30.

Furthermore, in this embodiment, external mails received from the outside of the organization 30 and internal mails are managed at the mail server 100 simply on the basis of source addresses without particular distinction between the external mails and the internal mails, and both the external mails and the internal mails are displayed simultaneously on occasion of a user's operation at one of the terminal apparatuses 31, 32, . . . . Alternatively, however, as needed, external mails and internal mails may be managed distinctly, and may also be displayed distinctly. Yet alternatively, the mail server 100 may be configured to deal with only external mails or only internal mails.

Furthermore, although the mail server 100 has the function of managing Web mails in this embodiment, without limitation to the embodiment, an independent apparatus different from the mail server 100, such as a server dedicated for Web mails, may have a function of managing Web mails, or an apparatus having another function, such as a server, may also have a function of managing Web mails.

The terminal apparatuses 21, 22, 23, . . . are computers provided outside the organization 30 so that users outside the organization 30 can send e-mails, receive e-mails, and perform other operations involving e-mails. Each of the terminal apparatuses 21, 22, 23, . . . has a function of sending and receiving e-mails.

The terminal apparatuses 31, 32, . . . are computers provided inside the organization 30 so that users inside the organization 30 can use Web mails provided by the mail server 100. Each of the terminal apparatuses 31, 32, . . . has a function of using Web mails provided by the mail server 100, and a function of operating the mail server 100 to send e-mails to and receive e-mails from the outside of the organization 30 via the Internet 20.

Next, the hardware configuration of the mail server 100 will be described.

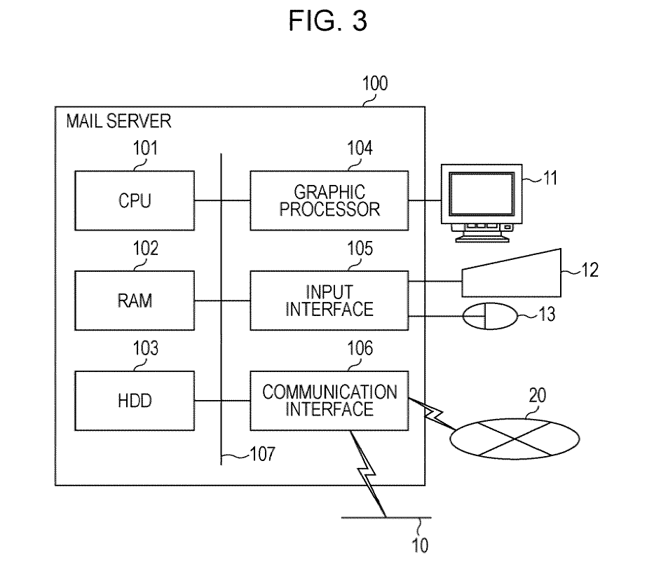

FIG. 3 is a diagram showing the hardware configuration of the mail server 100. The mail server 100 as a whole is controlled by a central processing unit (CPU) 101. The CPU 101 is connected to a random access memory (RAM) 102, a hard disk drive (HDD) 103, a graphic processor 104, an input interface 105, and a communication interface 106.

The RAM 102 temporarily stores at least part of an operating system (OS) program and application programs executed by the CPU 101. Furthermore, the RAM 102 stores various types of data needed for processing by the CPU 101. The HDD 103 stores the OS and application programs.

The graphic processor 104 is connected to a monitor 11. The graphic processor 104 displays images on a screen of the monitor 11 according to instructions from the CPU 101. The input interface 105 is connected to a keyboard 12 and a mouse 13. The input interface 105 sends signals sent from the keyboard 12 or the mouse 13 to the CPU 101 via a bus 107.

The communication interface 106 is connected to networks such as the LAN 10 and the Internet 20. The communication interface 106 sends data to and receives data from other computers via these networks.

The processing functions according to this embodiment can be implemented by the hardware configuration described above.

Next, the module configuration of the mail server 100 will be described.

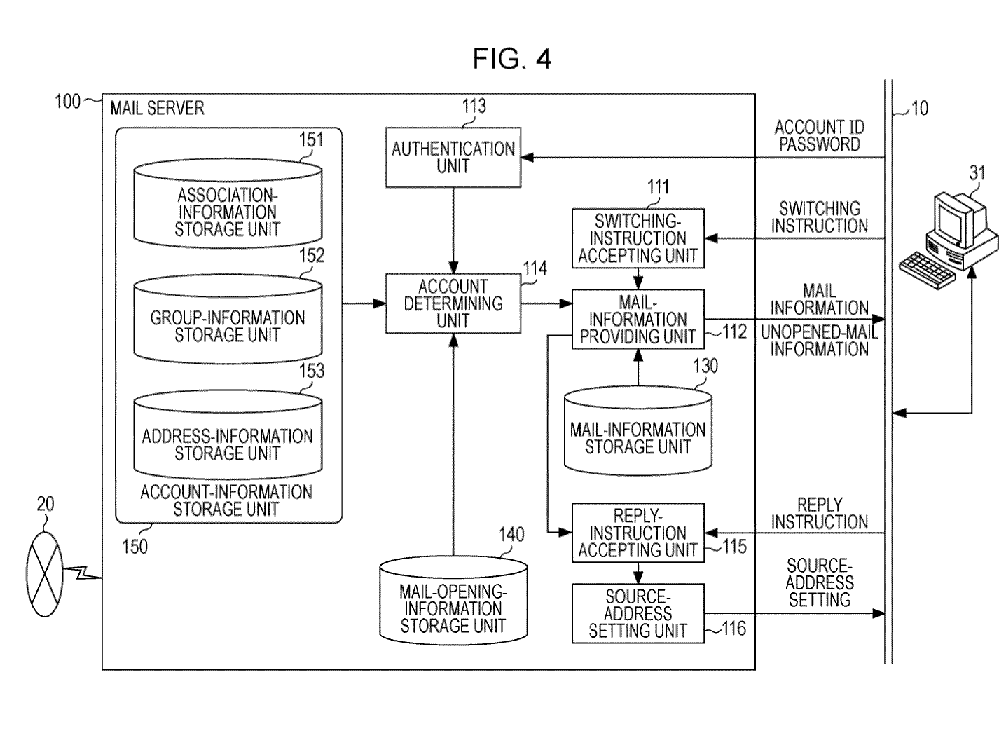

FIG. 4 is a block diagram showing the functions of a mail server.

The mail server 100 sends and receives e-mails, and manages a plurality of accounts. For the purpose of management of a plurality of accounts, the mail server 100 includes a switching-request accepting unit 111, a mail-information providing unit 112, an authentication unit 113, an account determining unit 114, a reply-instruction accepting unit 115, a source-address setting unit 116, a mail-information storage unit 130, a mail-opening-information storage unit 140, and an account-information storage unit 150.

Furthermore, the mail server 100 is connected via the LAN 10 to the terminal apparatus 31, at which a user reads e-mails, and is connected via the Internet 20 to external terminal apparatuses 21, 22, 23, . . . (see FIG. 2).

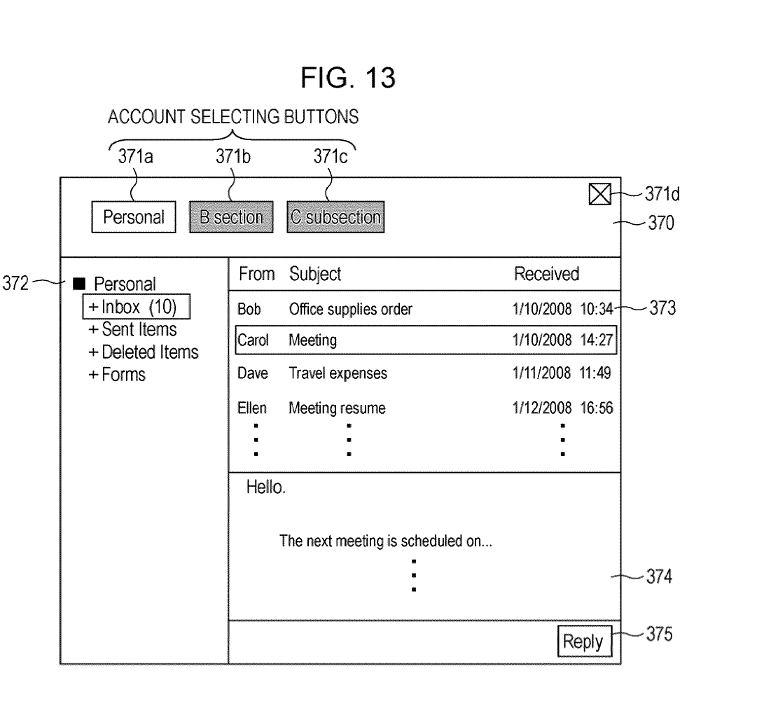

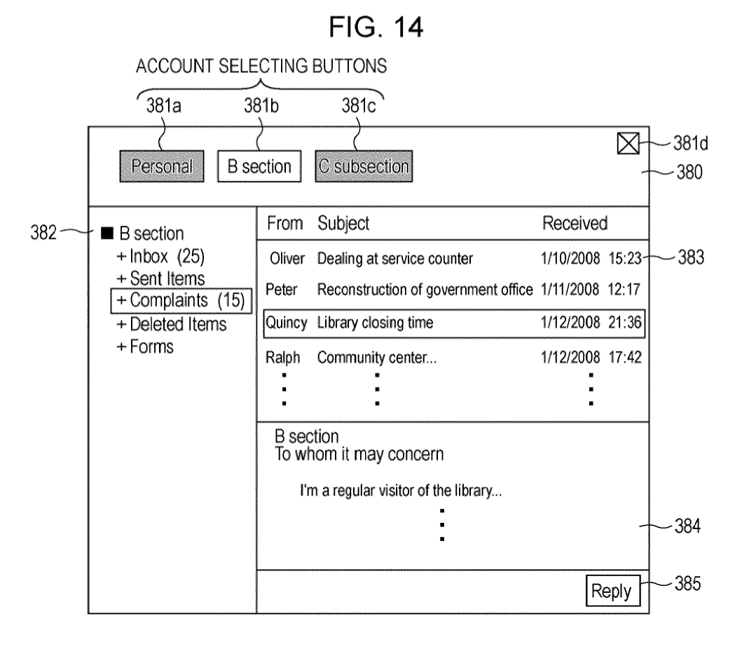

The switching-instruction accepting unit 111 accepts a switching instruction for switching an account for which mail information is provided by the mail-information providing unit 112 from one account to another account. The switching instruction is input by the user performing operation on the browser at the terminal apparatus 31. The switching instruction input to the terminal apparatus 31 is sent from the terminal apparatus 31 to the mail server 100 via the LAN 10. When the user inputs the switching instruction, the user specifies an account for switching. The operation for switching will be described later in detail with reference to FIGS. 13 and 14.

The mail-information providing unit 112 reads mail information from the mail-information storage unit 130. Furthermore, for each account for management of e-mails, the mail-information providing unit 112 provides the mail information that has been read via the LAN 10 to the terminal apparatus 31 where the user reads e-mails.

According to the switching instruction accepted by the switching-instruction accepting unit 111, the mail-information providing unit 112 switching the account for which mail information is read from the mail-information storage unit 130 and is provided to another account specified in the switching instruction.

The mail-information providing unit 112 provides the terminal apparatus 31 via the LAN 10 with unopened mail information and opened mail information indicating whether any unopened mail exists in the accounts other than the account for which mail information is provided by the mail-information providing unit 112.

At this time, the mail-information providing unit 112 first reads mail opening information from the mail-opening-information storage unit 140. Then, the mail-information providing unit 112 generates unopened mail information and opened mail information with reference to the mail opening information read from the mail-opening-information storage unit 140 to indicate whether any unopened mail exists in the accounts determined by the account determining unit 114. Then, the mail-information providing unit 112 provides the unopened mail information and opened mail information generated.

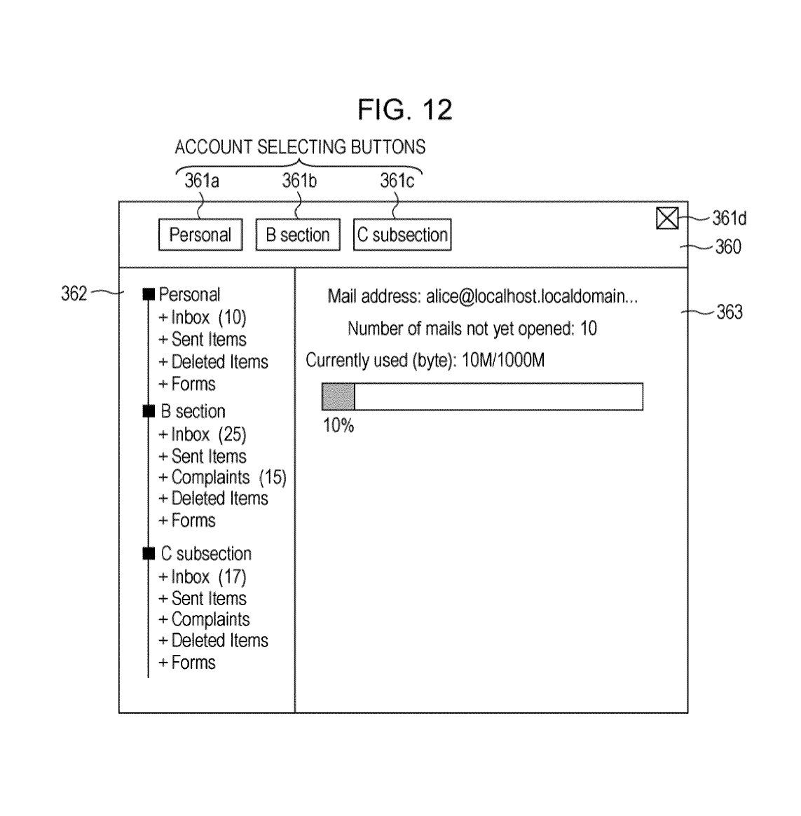

On the basis of the unopened mail information and opened mail information, information indicating whether any unopened mail exists is displayed on the browser of the terminal apparatus 31. The display of information regarding unopened mails and opened mails will be described later in detail with reference to FIGS. 12 to 14.

The authentication unit 113 performs authentication of a user on the basis of an account ID such as a user ID and a password associated with the account ID input to the terminal apparatus 31. Upon successful authentication, the mail server 100 permits log in by the user using the terminal apparatus 31, and provides mail information on the basis of the account corresponding to the account ID used for authentication. Thus, the user can read, by using the terminal apparatus 31, e-mails sent to the account corresponding to the account ID.

The account determining unit 114 reads account information from the account-information storage unit 150, and with reference to the account information, determines accounts at which the user authenticated by the authentication unit 113 is allowed to read e-mails.

The reply-instruction accepting unit 115 accepts from the terminal apparatus 31 an instruction for creating a reply mail to an e-mail read at an account for which mail information is provided by the mail-information providing unit 112.

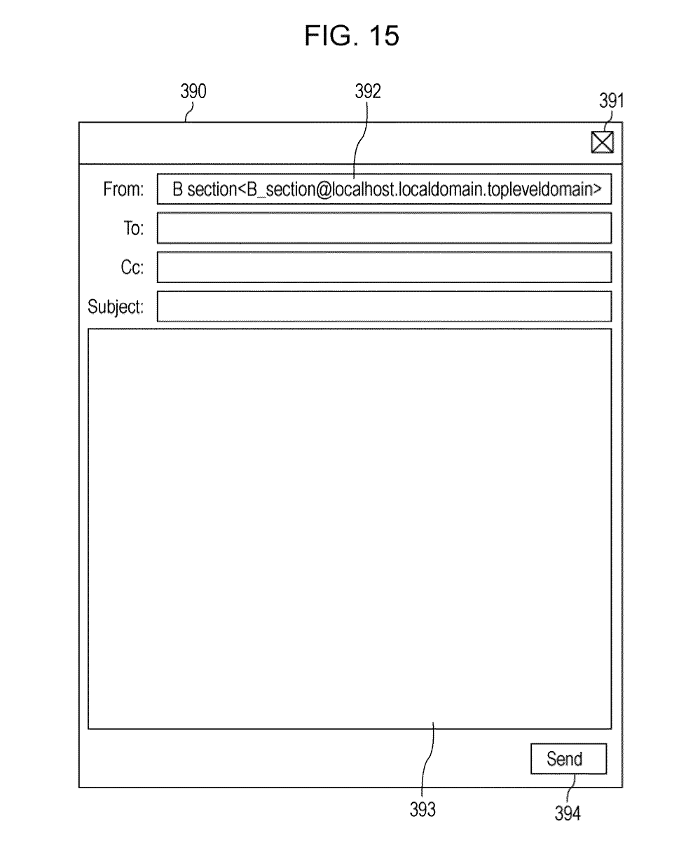

The source-address setting unit 116 sets the mail address of the account at the source of the reply instruction for the e-mail as a source address of the reply mail based on the reply instruction accepted by the reply-instruction accepting unit 115. The display on the browser of the terminal apparatus 31 and user's operation for setting the source address will be described later in detail with reference to FIG. 15.

The mail-information storage unit 130 stores mail information relating to e-mails. The mail information includes mail bodies and header information of internal mails created on the browsers of terminal apparatuses inside the organization 30 via the LAN 10, such as the terminal apparatus 31, and external mails sent from the outside of the organization 30 via the Internet 20 connected to the mail server 100. The header information includes information indicating a source address, a destination address, a date and time of sending, and so forth.

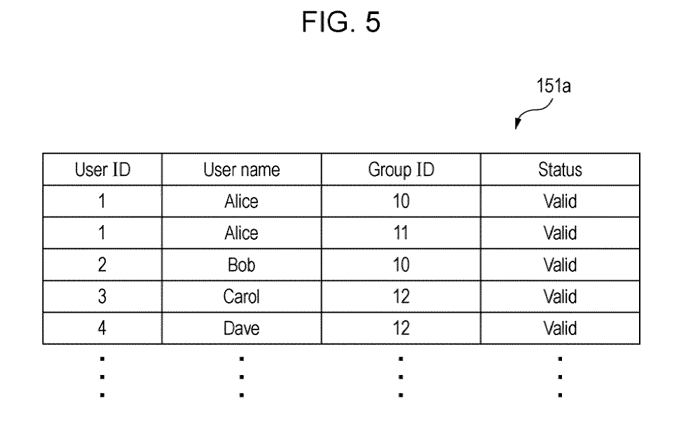

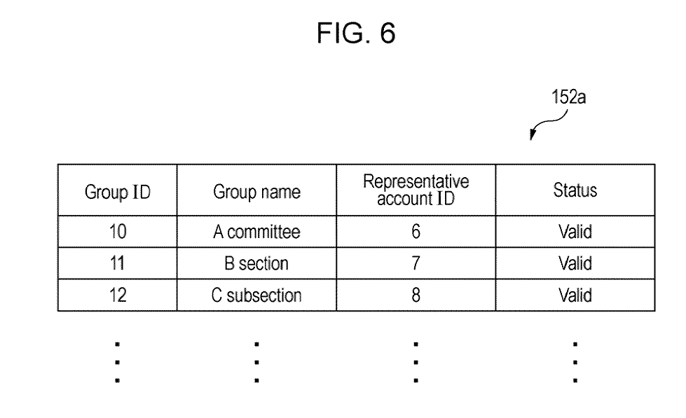

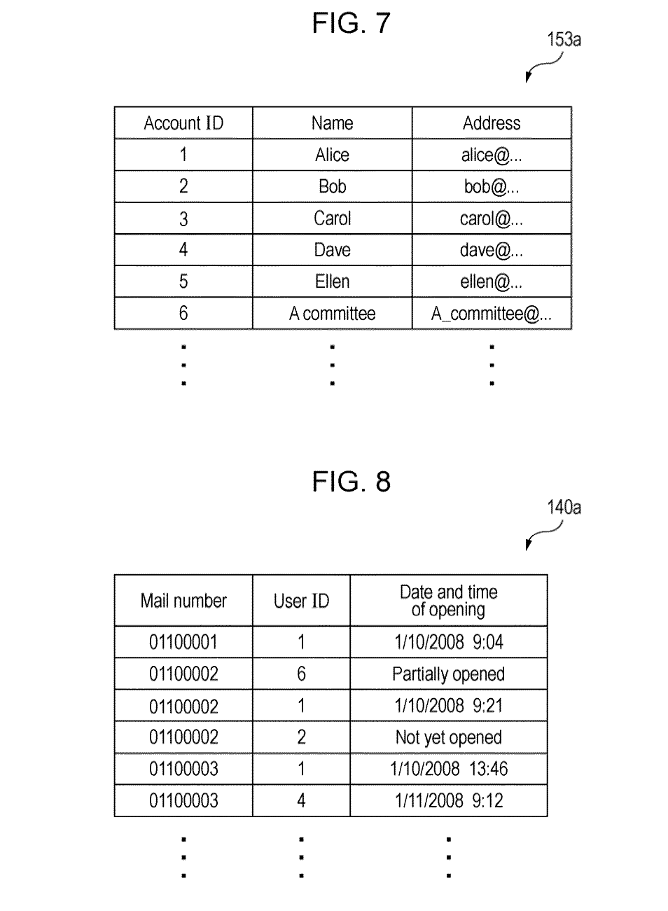

The account-information storage unit 150 stores account information identifying accounts at which users are allowed to read e-mails. The account information storage unit 150 includes an association-information storage unit 151, a group-information storage unit 152, and an address-information storage unit 153. The association-information storage unit 151 stores an association table 151a (see FIG. 5). The group-information storage unit 152 stores a group table 152a (see FIG. 6). The address-information storage unit 153 stores an address table 153a (see FIG. 7).

The mail-opening-information storage unit 140 stores mail opening information indicating whether each e-mail has been opened at the log-in account. The mail-opening-information storage unit 140 stores a mail opening table 140a (see FIG. 8).

The terminal apparatus 31 is connected to the mail server 100 via the LAN 10. The terminal apparatus 31 displays information relating to e-mails based on mail information provided from the mail server 100 according to user's operations. Furthermore, the terminal apparatus 31 outputs a switching instruction to the mail server 100 according to a user's operation.

In this embodiment, the mail server 100 has the functions described above. Without limitation to the embodiment, however, an independent apparatus different from the mail server 100, such as a dedicated server, may have all the functions described above. Yet alternatively, each of a plurality of apparatuses including the mail server 100 may have part of the functions described above so that the plurality of apparatuses as a whole has the functions described above.

Next, an association table used in the mail server 100 according to this embodiment will be described.

FIG. 5 is a diagram showing the data structure of an association table. The association table 151a shown in FIG. 5 is created and managed by the mail server 100. The association table 151a stores association information indicating corresponding relationship between individual users belonging to the organization 30 and individual groups of the organization 30.

The association table 151a includes “user ID” indicating an identifier (ID) assigned to each user in the organization 30, “user name” indicating a name of the user, “group ID” indicating an ID assigned to a group to which the user belongs, and “status” indicating the validity of the user ID. The items of information in each row are associated with each other to constitute association information. Although not shown in FIG. 5, the association information also includes a password used for authentication of the user in combination with the user ID.

The user ID is a code assigned to each user for identification of the user in the mail system, such as the mail server 100. Thus, an arbitrary text string can be used as the user ID as long as the user ID allows unique identification of the user. The user name is a name of a user who belongs to the organization 30 and who uses the mail system.

The group ID is a code assigned to each group for identification of the group in the mail system. Thus, similarly to the user ID, an arbitrary code can be used as the group ID as long as the group ID allows unique identification of the group.

The status indicates the validity of the user ID. A “valid” status indicates that the user ID is usable. On the other hand, an “invalid” status indicates that the use of the user ID has been invalidated.

Each user can belong to one or more groups. In this embodiment, when a user belongs to a plurality of groups, a plurality of pieces of association information is created for the user, for example, as shown in the first and second rows from the top of the association table 151a shown in FIG. 5, so that the same user ID is associated with different group IDs individually in the pieces of association information.

Next, a group table used by the mail server 100 according to this embodiment will be described.

FIG. 6 is a diagram showing the data structure of a group table. The group table 152a shown in FIG. 6 is created and managed by the mail server 100. The group table 152a stores group information indicating information regarding each group of the organization 30.

The group table 152a includes “group ID” indicating an ID of each group of the organization 30, “group name” indicating a name of the group, “representative account ID” indicating a representative account ID for identifying a mail address assigned to the group, and “status” indicating the validity of the group ID. The items of information in each row are associated with each other to constitute group information.

As described earlier, the group ID is a code assigned to each group for identification of the group in the mail system. The group name is a name of each group of the organization 30 that uses the mail system.

The representative account ID is a code assigned to each group in order to associate the group with a representative address assigned to the group. Thus, similarly to the group ID, an arbitrary text string can be used as the representative account ID as long as the representative account ID allows unique identification of the group.

The status indicates the validity of the group ID. A “valid” status indicates that the group ID is usable. On the other hand, an “invalid” status indicates that the use of the group ID has been invalidated.

Next, an address table used by the mail server 100 according to this embodiment will be described.

FIG. 7 is a diagram showing the structure of an address table. The address table 153a shown in FIG. 7 is created and managed by the mail server 100. The address table 153a stores address information indicating address information of each user and each group of the organization 30.

The address table 153a includes “account ID” indicating a user ID of a user having a mail address or a group ID of a group having a mail address, “name” indicating a name of the user or group, and “address” indicating the mail address assigned to the user or group. The items of information in each row are associated with each other to constitute address information.

The account ID is a code assigned to each user and each group in order to associate each user with a mail address assigned to the user and each group with a representative mail address assigned to the group in the address table 153a. The name is a name of the user or group. The address is the mail address assigned to the user or the representative mail address assigned to the group.

In this embodiment, each group can have one representative address. Without limitation, however, each group may have two or more representative addresses assigned thereto. In this case, a plurality of pieces of address information is created for the same group, so that the same account ID (representative address ID) is associated with different representative mail addresses in the individual pieces of address information.

E-mails received at personal addresses and e-mails received at representative addresses are managed and stored in the mail-information storage unit on an account-by-account basis. When a user issues a request for reading e-mails from one of the terminal apparatuses 31, 32, . . . that the user uses to the mail server 100, on the basis of the association information, group information, and address information shown in FIGS. 5 to 7, for each account at which the user is allowed to read e-mails, mail information is provided to the terminal apparatus that the user uses, and mail bodies, the presence or absence of unopened mails, the number of unopened mails, and so forth are displayed on the browser on an account-by-account basis (see FIGS. 12 to 15).

FIG. 8 is a diagram showing the data structure of a mail opening table. The mail opening table 140a shown in FIG. 8 is created and managed by the mail server 100. The mail opening table 140a stores mail opening information indicating whether each e-mail received by the mail server 100 has been opened by each user, and a date and time of opening by each user. As described earlier, e-mails include both internal mails and external mails.

The mail opening table 140a includes “mail number” indicating a number uniquely assigned to each e-mail for identification of the e-mail, “user ID” indicating a user who opened the e-mail, and “date and time of opening” indicating whether the e-mail identified by the mail number has been opened at the account corresponding to the user ID and a date and time of opening. The items of information in each row are associated with each other to constitute mail opening information.

The mail number is a number uniquely assigned to each e-mail received by the mail server 100 for the purpose of identification of the e-mail by the mail server 100. The mail number of an external mail is assigned at the time of reception of the external mail by the mail server 100 via the Internet 20. The mail number of an internal mail is assigned at the time of storage at the mail server 100 of the internal mail sent via the LAN 10 to the mail server 100 after the internal mail is created at one of the terminal apparatuses 31, 32, . . . .

The user ID indicates a user who is opened the e-mail identified by the mail number. More specifically, a mail address to which the e-mail identified by the mail number is addressed is obtained, and a user corresponding to the mail address is recorded. The date and time of opening indicates whether the e-mail identified by the mail number has been opened by the user identified by the user ID, and a date and time of opening by the user.

Each time an external mail sent from the outside of the organization 30 is received and each time an internal mail is created inside the organization 30, the mail server 100 creates mail opening information as shown on each row of the mail opening table 140a. Since the e-mail is not yet opened at this time, “not yet opened” is set as the date and time of opening.

The mail opening information is created individually for each e-mail opened and for each account corresponding to a destination of the e-mail. That is, if an e-mail has a plurality of destination addresses, the mail opening information is created for each user to which the e-mail is addressed, for example, as in the mail opening information on the fifth and sixth rows of the mail opening table 140a shown in FIG. 8.

Furthermore, if an e-mail is addressed to a representative address (e.g., the e-mail identified by the mail number “01100002” on the second to fourth rows from the top of the mail opening table 140a), mail opening information is created for the group corresponding to the representative address (e.g., the group identified by the user ID “6”), and mail opening information is created for each of a plurality of users belonging to the group corresponding to the representative address (e.g., three users identified by the user IDs “1”, “2”, and “6”).

Then, each time a user logs in to the mail system and reads an e-mail, the mail server 100 obtains a date and time of opening (and minute and second, hereinafter the same throughout this specification), and the date and time of opening obtained is written as the date and time of opening in mail opening information corresponding to the mail number assigned to the e-mail read by the user and the user ID indicating the account of the user who opened the e-mail. In the case of an e-mail addressed to a group, if the e-mail has not been opened by all the users but has been opened by some users, “partially opened” is set as the date and time of the opening of the e-mail addressed to the group (e.g., the second row from the top of the mail opening table 140a). Then, when the e-mail has been opened by all the users to which the e-mail is addressed, similarly to the case of a personal user ID, a date and time of opening is written as the date and time of opening corresponding to the user ID of the group for the e-mail.

The mail opening information maintains records as to whether each e-mail managed by the mail server 100 has been opened by each user. Thus, with the mail server 100 according to this embodiment, it is possible to manage whether each e-mail has been read by each user.

Next, the procedure of a process executed by the mail system according to this embodiment will be described. First, a mailbox process that is executed when a user checks received e-mails in the mail server 100 according to this embodiment will be described.

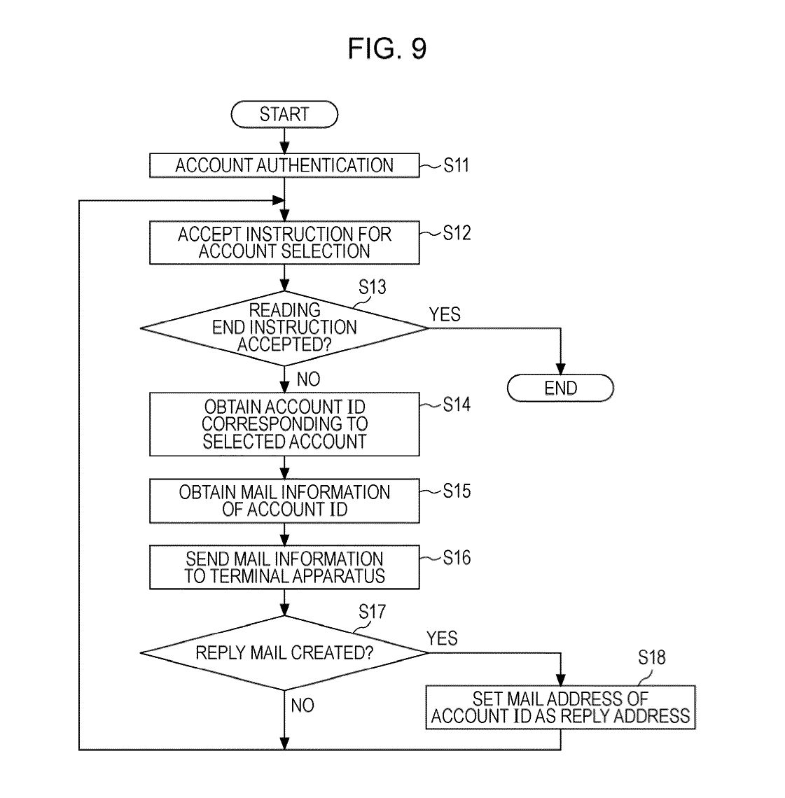

FIG. 9 is a flowchart showing the procedure of the mailbox process.

Upon receiving an e-mail operation request sent from one of the terminal apparatuses 31, 32, . . . (e.g., the terminal apparatus 31) used by a user belonging to the organization 30, the mail server 100 according to this embodiment executes the mailbox process to provide the terminal apparatus with information of e-mails addressed to the user so that the information is displayed on the browser of the terminal apparatus.

In step S11, upon receiving an e-mail reading request from the user of the terminal apparatus 31, the CPU 101 of the mail server 100 performs account authentication regarding the user ID of the personal account of the user via the LAN 10. Upon successful account information, the user is allowed to log in to the mail system by the authenticated account.

In step S12, the CPU 101 accepts a user's instruction for selecting an account at which the user wishes to read e-mails, sent from the terminal apparatus 31. Thus, the e-mail account at which the user wishes to read e-mails among the personal address and representative address is reported from one of the terminal apparatuses 31, 32, . . . to the mail server 100.

In step S13, the CPU 101 determines whether an operation end instruction sent from one of the terminal apparatuses 31, 32, . . . has been accepted. If an operation instruction has not been accepted, the process proceeds to step S14. On the other hand, if an operation end instruction has been accepted, the process is exited.

In step S14, on the basis of the selecting instruction accepted in step S12, the CPU 101 obtains an account ID (see FIG. 7) corresponding to the e-mail account selected by the user. Thus, when the user has selected to read e-mails at the personal address on the browser of one of the terminal apparatuses 31, 32, . . . , an account ID corresponding to the personal address is obtained. On the other hand, when the user has selected to read e-mails at the representative address, an account ID corresponding to the representative address is obtained.

In step S15, the CPU 101 obtains mail information corresponding to the account ID obtained in step S14.

In step S16, the CPU 101 sends the mail information obtained in step S15 to one of the terminal apparatuses 31, 32, . . . at the source of the reading request from the user.

In step S17, the CPU 101 determines whether the user has created a reply mail on one of the terminal apparatuses 31, 32, . . . at the account selected in step S12. If the user has created a reply mail, the process proceeds to step S18. On the other hand, if the user has not created a reply mail, the process proceeds to step S12.

In step S18, as a reply address that serves as a source of the reply mail (reply source) created by the user, the CPU 101 sets the mail address of the account ID obtained, which is the address of the account selected in step S12. This will be described later in detail with reference to FIG. 15. Thus, when the user replies to an e-mail at the personal address, the user creates a reply mail in which the personal address is set as a reply address. On the other hand, when the user replies to an e-mail at the representative address, the user creates a reply mail in which the representative address is set as a reply address.

In the embodiment described above, the mail server 100 sets a reply address before a user creates a reply mail. Without limitation, however, the mail server 100 may automatically change a reply address to a mail address of a corresponding account after a user creates a reply mail and issues a sending instruction, and then send the reply mail to a destination. Yet alternatively, instead of automatically changing the reply address, the mail server 100 may display an alert message or a confirmation message for the user or send an alert message or a confirmation message to a third party in a case where the destination address of the e-mail received does not coincide with the reply address of the reply mail created by the user. Furthermore, these schemes may be used in combination with each other.

Next, a process that is executed a user reads e-mails in the mail system according to this embodiment will be described.

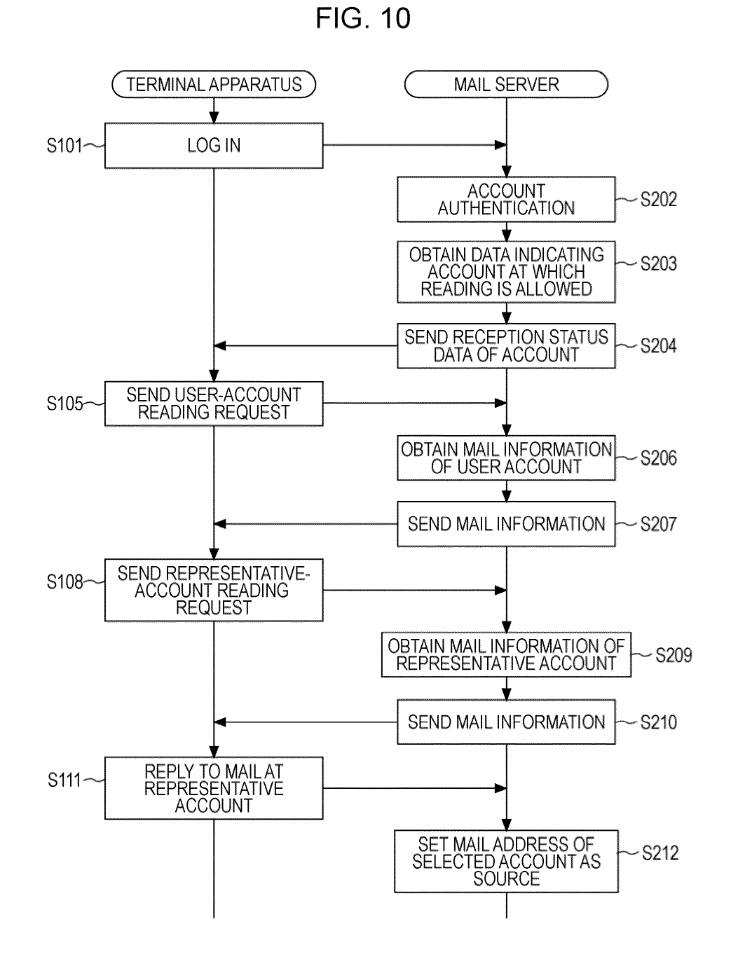

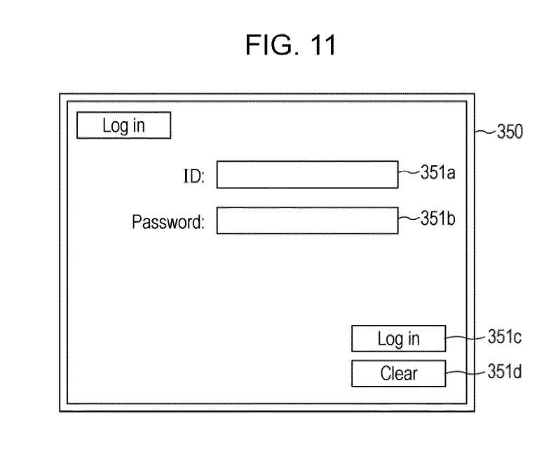

FIG. 10 is a sequence diagram showing the procedure of the process executed when a user reads e-mails in the mail system.

In the mail system according to this embodiment, when a user in the organization 30 reads a Web mail by using one of the terminal apparatuses 31, 32, . . . inside the organization 30 (e.g., the terminal apparatus 31), the following procedure is executed. The Web mail may be either an external mail sent to a personal user or group in the organization 30 from one of the terminal apparatuses 21, 22, 23, . . . outside the organization 30 or an internal mail created for a personal user or group in the organization 30 at one of the terminal apparatuses 31, 32, . . . inside the organization 30 (e.g., the terminal apparatus 31).

In step S101, the terminal apparatus 31 accepts input of an account ID and a password by a user in the organization 30, and sends the account ID and the password to the mail server 100 via the LAN 10.

In step S202, upon receiving the account ID and password sent from the terminal apparatus 31, the mail server 100 performs account authentication on the basis of the account ID and password received in order to check the validity of the user.

In step S203, the mail server 100 obtains account information indicating an account associated with the account ID of the user who has logged in from the association-information storage unit 151, the group-information storage unit 152, and the address-information storage unit 153 of the account-information storage unit 150. Thus, accounts at which the user who has logged in is allowed to read e-mails are identified.

In step S204, the mail server 100 sends information indicating the status of e-mails received at the accounts at which the user is allowed to read e-mails to the terminal apparatus 31 via the LAN 10. The information indicating the status of e-mails includes mail opening information (see FIG. 8).

In step S105, when the user has performed an operation on the browser to issue an instruction for reading e-mails at the user account corresponding to the personal address, the terminal apparatus 31 sends a user-account reading request to the mail server 100 via the LAN 10.

In step S206, upon receiving the user-account reading request from the terminal apparatus 31, the mail server 100 obtains mail information of the user account relevant to the user's request from the mail-information storage unit 130. The mail information that is obtained is mail information of e-mails sent to the personal account of the user who has logged in. The mail information also includes data such as mail information of e-mails sent by the user in the past, the body of an e-mail being created, and so forth at the personal account of the user.

In step S207, the mail server 100 sends the mail information of the user account obtained in step S206 to the terminal apparatus 31 via the LAN 10. Upon receiving the mail information, the terminal apparatus 31 displays the content of e-mails and so forth on the browser.

In step S108, when the has performed an operation on the browser to issue an instruction for reading e-mails at a representative account corresponding to a representative address, the terminal apparatus 31 sends a representative-account reading request to the mail server 100 via the LAN 10.

In step S209, upon receiving the representative-account reading request from the terminal apparatus 31, the mail server 100 obtains mail information of the representative account relevant to the user's request from the mail-information storage unit 130. The mail information that is obtained is mail information of e-mails sent to the representative address of the user who has logged in. The mail information also includes data such as mail information of e-mails sent by the user in the past, the body of an e-mail being created, and so forth at the representative account.

In step S210, the mail server 100 sends the mail information of the representative account obtained in step S209 to the terminal apparatus 31 via the LAN 10. Upon receiving the mail information, the terminal apparatus 31 displays the content of e-mails and so forth on the browser.

In step S111, upon receiving when the user has performed an operation on the browser to issue an instruction for creating a reply mail for an e-mail at the representative account, the terminal apparatus 31 sends a request for creating a reply mail at the representative account to the mail server 100 via the LAN 10.

In step S212, upon receiving the representative-account reply-mail creating request sent from the terminal apparatus 31, the mail server 100 sets the mail address of the representative account (representative address), which is the account specified in the reading request in step S108. Thus, the user creates a reply mail in which the representative address is set as a source address by the browser on the terminal apparatus 31.

When the user creates a reply mail for an e-mail received at the personal address, similarly, the personal address is set as a reply address.

Next, display screens displayed on the browsers of the terminal apparatuses 31, 32, . . . when the mailbox process is executed will be described.

FIG. 11 is an illustration showing a log-in screen. A log-in screen 350 shown in FIG. 12 is an example of a log-in screen displayed on a browser on a monitor (not shown) connected to one of the terminal apparatuses 31, 32, . . . (e.g., the terminal apparatus 31) operated by a user inside the organization 30 when the user performs a log-in operation for logging into the mail system in order to read e-mails.

The log-in screen 350 includes an ID input field 351a, a password input field 351b for accepting input of a password, a log-in button 351c for accepting an operation for causing the mail server 100 to execute account authentication for log in when the ID and password input to the ID input field 351a and the password input field 351b are valid, and a clear button 351d for accepting an operation for canceling information that has been input when the ID and password input to the ID input field 351a and the password input field 351b are not valid.

A user who logs into the mail system inputs a user ID assigned in advance to the ID input field 351a and a password associated with the user ID to the password input field 351b, and then operates the log-in button 351c. Accordingly, the mail server 100 executes account authentication, so that the user is allowed to log into the mail system.

FIG. 12 is an illustration showing a post-log-in screen. A post-log-in screen 360 shown in FIG. 12 is an example of a post-log-in screen displayed on the browser on the monitor (not shown) connected to one of the terminal apparatuses 31, 32, . . . (e.g., the terminal apparatus 31) operated by the user in the organization 30 immediately after the user logs into the mail system to read e-mails.

The post-log-in screen 360 includes account selecting buttons 361a, 361b, and 361c for accepting an operation for selecting an account, a close button 361d for accepting an operation for quitting reading e-mails, a folder display area 362 for displaying the status of e-mail folders at accounts at which the user is allowed to perform operations, and an account-information display area 363 for displaying the status of reception of e-mails at the account that the user has logged into.

In the folder display area 362, accounts at which the user is allowed to read e-mails (e.g., “personal”, “B section”, and “C subsection”), and folders at the accounts (e.g., “inbox”, “sent items”, “deleted items”, “forms”, and “complaints”) are displayed.

In the folder display area 362, for each of the personal and representative addresses corresponding to the accounts at which the user is allowed to read e-mails, the number of unopened (unread) mails at the account is displayed on a folder-by-folder basis.

More specifically, referring to FIG. 12, “Inbox (10)” for the personal address indicates that 10 unopened mails exist in the inbox folder of the personal address. Furthermore, “Inbox (25)” for the B section indicates that 25 unopened mails exist in the user's account at the representative address of the B section. The mail server 100 can determine whether each e-mail has been opened or not with reference to the mail opening information stored in the mail opening table 140a (see FIG. 8).

In the account-information display area 363, the mail address of the account that the user has logged into, and the status of reception at the mail address, such as the number of unopened mails and the amount of storage currently used, are displayed. For example, in the case where the user has logged in with the personal address, the status of reception at the personal address is displayed in the account-information display area 363.

The user who has logged into the mail system can recognize the presence or absence of unopened mails and the number of unopened mails at each account with reference to the folder display area 362. In the case where the user reads e-mails at an account having any unopened mail, the user can switch to account display screens 370 and 380, which will be described later in detail with reference to FIGS. 13 and 14, by operating one of the account selecting buttons 361a, 361b, and 361c corresponding to an account at which the user wishes to read e-mails. If the user does not wish to read e-mails at any of the accounts, the user can log out of the mail system by operating the close button 361d.

FIG. 13 is an illustration showing an account display screen for a personal address. The account display screen 370 shown in FIG. 13 is an example of an account display screen displayed on the browser on the monitor (not shown) connected to one of the terminal apparatuses 31, 32, . . . (e.g., the terminal apparatus 31) operated by the user inside the organization 30, showing e-mails received at the personal address.

Similarly to the post-log-in screen 360, the account display screen 370 includes account selecting buttons 371a, 371b, and 371c, a close button 371d, and a folder display area 372. Furthermore, in the account display screen 370, a list display area 373 for displaying a list of e-mails in a folder selected in the folder display area 372, a body display area 374 for displaying the body of an e-mail selected in the list display area 373, and a reply button 375 that is operated by the user when the user creates a reply to the e-mail displayed in the body display area 374 are provided.

In FIG. 13, the account selecting button 371a, corresponding to the personal account, is displayed in white. On the other hand, the other account selecting buttons 371b and 371c are displayed as shaded. This indicates that the account of e-mails displayed in the list display area 373 is the personal account. The user can switch the e-mails displayed to e-mails of other accounts corresponding to the account selecting buttons 371b and 371c by operating the account selecting buttons 371b and 371c. Furthermore, the user can log out of the mail server and close the display of e-mails by operating the close button 371d.

When the user wishes to create a reply mail to an e-mail viewed at the personal account displayed in the body display area 374, the user operates the reply button 375 to open a reply-mail creating screen 390, which will be described later in detail with reference to FIG. 16.

FIG. 14 is an illustration showing an account display screen for a representative address. The account display screen 380 shown in FIG. 14 is an example of an account display screen displayed on the browser on the monitor (not shown) connected to one of the terminal apparatuses 31, 32, . . . (e.g., the terminal apparatus 31) operated by the user inside the organization 30, showing e-mails received at the representative address of the B section, which is one of the representative addresses.

Similarly to the account display screen 370 shown in FIG. 13, the account display screen 380 includes account selecting buttons 381a, 381b, and 381c, a close button 381d, a folder display area 382, a list display area 383, a body display area 384, and a reply button 385.

In FIG. 14, the account selecting button 381b, corresponding to the representative account of the B section, is displayed in white. On the other hand, the other account selecting buttons 381a and 381c are displayed as shaded. This indicates that the account of e-mails displayed in the list display area 383 is the representative account of the B section. The user can switch the e-mails displayed to e-mails of other accounts corresponding to the account selecting buttons 381a and 381c by operating the account selecting buttons 381a and 381c. Furthermore, the user can log out of the mail server and close the display of e-mails by operating the close button 381d.

When the user wishes to create a reply mail to an e-mail viewed at the representative account displayed in the body display area 384, the user operates the reply button 385 to open a reply-mail creating screen 390, which will be described later in detail with reference to FIG. 15.

FIG. 15 is an illustration showing a reply-mail creating screen. A reply-mail creating screen 390 shown in FIG. 15 is an example of a reply-mail creating screen displayed on the browser on the monitor (not shown) connected to one of the terminal apparatuses 31, 32, . . . (e.g., the terminal apparatus 31) operated by the user inside the organization 30 when the user creates a reply mail to an e-mail that the user has read.

The reply-mail creating screen 390 includes a close button 391, a source-address input field 392 for accepting input of a sender address at the source of the reply mail (reply source), a body input area 393 for accepting input of a body of the reply mail, and a send button 394 that is operated by the user when sending the reply mail that has been created.

Referring to FIG. 13 or 14, when the user has read the e-mail displayed in the body display area 374 or 384 and then wishes to create a reply mail to the e-mail, the user operates the reply button 375 or 385 to open the reply-mail creating screen 390 on the browser at the terminal apparatus 31. The user can create a reply mail to the e-mail by entering a mail body in the body input area 393.

In the source-address input field 392, the mail address of the account at which the e-mail to which a reply mail is being created was read is input in advance. More specifically, for example, as shown in FIG. 14, when the user creates a reply mail to an e-mail read at a representative account, as shown in FIG. 15, the representative address, i.e., the mail address of the representative account at which the e-mail was read, is input as a source address. When the user creates a reply mail to an e-mail read at the personal account as shown in FIG. 13, the personal address, i.e., the mail address of the personal account at which the e-mail was read, is input as a source address.

Thus, an appropriate source address is set to the reply mail created by the mail system. Accordingly, it is possible to prevent a mistake of sending an e-mail in which another account of the user is set as a source address (sender). This serves to prevent corresponding leakage of a personal address to the outside. For example, it is possible to prevent it from being accidentally known to the outside which user in the organization 30 sent the e-mail, so that personal information can be protected.

Furthermore, users registered at the mail server 100 can readily share information regarding e-mails addressed to a representative address, which has not been possible in existing Web mail systems.

Furthermore, in addition to information displayed in existing systems when a user has logged in to a personal account, it is possible to visually recognize the status of reception of e-mails at a representative address.

As described above, since it is possible to perform switching of e-mail information provided among a plurality of accounts according to a switching instruction by the user, it is possible to perform switching of display regarding e-mails among the plurality of accounts according to a switching instruction by the user at a terminal apparatus inside the organization 30. This facilitates user's reading of e-mails at a plurality of mail accounts.

Furthermore, since the presence or absence of any unopened mails and the number of unopened mails are displayed in the post-log-in screen 360 and the account display screens 370 and 380 even for an account different from an account for which mail information is displayed, without selecting all the accounts one by one, it is possible to determine whether mail information of other accounts should be displayed. This serves to reduce user's tasks for mail management.

Hereinabove, a mail sending and receiving program, a mail sending and receiving apparatus, and a mail sending and receiving system according to an embodiment of the present invention have been described. Although the above description explains the principle of the present invention merely, the present invention is not limited to the exact exemplary configurations and applications described above. It is to be understood that various modifications and alternatives can be conceived by those skilled in the art. All corresponding modifications, alternatives, and equivalents are considered as falling in the scope of the present invention as claimed and its equivalents. The configuration of individual parts can be replaced with arbitrary configurations having similar functions. Furthermore, arbitrary configurations or steps may be added when embodying the present invention. Furthermore, the present invention covers a combination of arbitrary two or more configurations (features) of the embodiments described above.

The above processing functions can be implemented by a computer. In that case, a program defining processing for intended functions of the mail server 100 is provided. The processing functions are implemented on a computer by executing the program on the computer.

The program defining the processing can be recorded on a computer-readable medium. The computer-readable medium is, for example, a magnetic recording medium, an optical disc, a magneto-optical recording medium, or a semiconductor memory. The magnetic recording medium is, for example, an HDD, an FD (flexible disk), or an MT (magnetic tape). The optical disc is, for example, a DVD (digital versatile disc), a DVD-RAM, a CD-ROM (compact disc read-only memory), or a CD-R (recordable)/RW (rewritable). The magneto-optical recording medium is, for example, an MO (magneto-optical disk).

In order to distribute the program, for example, a portable recording medium having the program recorded thereon, such as a DVD or CD-ROM, is sold. Alternatively, the program may be stored at a server computer and transferred from the server computer to another computer via a network.

For example, a computer that executes the program installs the program recorded on the portable recording medium or transferred from the server computer on a storage device of its own. Then, the computer reads the program from the storage device and executes processing according to the program. Alternatively, the computer may read the program directly from the portable recording medium and execute processing according to the program. Yet alternatively, the computer may execute processing according to the program each time upon receiving the program from the server computer.

What is claimed is:

1. A computer-readable medium comprising computer-executable instructions for performing a method, execution of which by a computer facilitates sending and receiving e-mails, the method including:
reading mail information from a mail-information memory regarding accessible e-mail accounts to which an authenticated user is permitted to have access;
providing the mail information specific to a first one of the accessible email accounts;
accepting a switching instruction to switch to a second one of the accessible email accounts; and
automatically providing the mail information specific to the second one of the accessible email accounts upon accepting the switching instruction.

2. The computer-readable medium according to claim 1, wherein the method further comprises:
reading mail-opening information from a mail-opening information memory regarding the accessible e-mail accounts, the mail-opening information indicating which e-mails have been opened and which have not at the accessible email accounts; and
providing the mail-opening information for ones of the accessible email accounts other than the email account for which mail information is currently being provided.

3. The computer-readable medium according to claim 1, wherein the method further comprises:
accepting a reply instruction for creating a reply mail relative to an e-mail read at the second one of the accessible email accounts; and
setting a reply address for the reply email to be the address associated with the second one of the accessible email accounts.

4. The computer-readable medium according to claim 3, wherein:
the setting of the reply address occurs automatically upon accepting the switching instruction.

5. The computer-readable medium according to claim 3, wherein:
the setting of the reply address occurs automatically upon accepting the reply instruction.

6. The computer-readable medium according to claim 3, wherein:
the setting of the reply address occurs automatically upon accepting the reply instruction.

7. The computer-readable medium according to claim 1, wherein the method further comprises:
accepting a reply instruction for creating a reply mail relative to an e-mail read at the second one of the accessible email accounts; and
displaying one of an alert message and a confirmation to the authenticated user, the alert message indicating that the reply address of the reply email does not correspond to the address associated with the second one of the accessible email accounts, and the confirmation message requesting confirmation from the authenticated user that he desires to proceed despite the reply address of the reply email not corresponding to the address associated with the second one of the accessible email accounts.

8. The computer-readable medium according to claim 1, wherein the method further comprises:
accepting a reply instruction for creating a reply mail relative to an original e-mail read at the second one of the accessible email accounts; and
at least one of incorporating or appending to the reply email an alert message that the destination address of the original e-mail does not coincide with the reply address of the reply mail.

9. A method to facilitate sending and receiving e-mails, the method including:
reading mail information from a mail-information memory regarding accessible e-mail accounts to which an authenticated user is permitted to have access;
providing the mail information specific to a first one of the accessible email accounts;
receiving a switching instruction to switch to a second one of the accessible email accounts; and
automatically providing the mail information specific to the second one of the accessible email accounts upon accepting the switching instruction.

10. The method according to claim 9, further comprising:
reading mail-opening information from a mail-opening information memory regarding the accessible e-mail accounts, the mail-opening information indicating which e-mails have been opened and which have not at the accessible email accounts; and
providing the mail-opening information for ones of the accessible email accounts other than the email account for which mail information is currently being provided.

11. The method according to claim 9, further comprising:
accepting a reply instruction for creating a reply mail relative to an e-mail read at the second one of the accessible email accounts; and
setting a reply address for the reply email to be the address associated with the second one of the accessible email accounts.

12. The method according to claim 11, wherein:
the setting of the reply address occurs automatically upon receiving the switching instruction.

13. The method according to claim 11, wherein:
the setting of the reply address occurs automatically upon accepting the reply instruction.

14. The method according to claim 11, wherein:
the setting of the reply address occurs automatically upon accepting the reply instruction.

15. The method according to claim 9, further comprising:
accepting a reply instruction for creating a reply mail relative to an e-mail read at the second one of the accessible email accounts; and
displaying one of an alert message and a confirmation to the authenticated user, the alert message indicating that the reply address of the reply email does not correspond to the address associated with the second one of the accessible email accounts, and the confirmation message requesting confirmation from the authenticated user that he desires to proceed despite the reply address of the reply email not corresponding to the address associated with the second one of the accessible email accounts.

16. The method according to claim 9, wherein the method further comprises:
accepting a reply instruction for creating a reply mail relative to an original e-mail read at the second one of the accessible email accounts; and
at least one of incorporating or appending to the reply email an alert message that the destination address of the original e-mail does not coincide with the reply address of the reply mail.

17. A mail sending and receiving apparatus for sending and receiving e-mails, the apparatus comprising:
a mail-information memory to store mail information relating to e-mail accounts;
a mail-information providing unit to read the mail information from the mail-information memory regarding email accounts to which an authenticated user is permitted to have access, and to provide the mail information specific to a first one of the accessible email accounts; and
a switching-instruction accepting unit to accept a switching instruction for switching to a second one of the accessible email accounts;
the mail-information providing unit further being operable to automatically provide the mail information for the second one of the accessible email accounts upon acceptance of the switching instruction.

18. A mail sending and receiving system for sending and receiving e-mails, the system comprising:
a mail sending and receiving apparatus; and
a terminal apparatus connected to the mail sending and receiving apparatus via a communication circuit,
wherein the mail sending and receiving apparatus includes:
a mail-information memory to store mail information relating to e-mail accounts;
a mail-information providing unit that to read the mail information from the mail-information memory regarding email accounts to which an authenticated user is permitted to have access, and to provide the mail information specific to a first one of the accessible email accounts;
a switching-instruction accepting unit to accept a switching instruction for switching to a second one of the accessible email accounts; and
a controller to cause information regarding e-mails provided from the mail sending and receiving apparatus to be displayed according to an operation by the authenticated user;
the mail-information providing unit further being operable to automatically provide the mail information for the second one of the accessible email accounts upon acceptance of the switching instruction by the switching-instruction accepting unit.
